(19) United States
(12) Patent Application Publication
(10) Pub. No.: US 2025/0039695 A1
(43) Pub. Date: Jan. 30, 2025

(54) METHOD AND APPARATUS FOR MANAGING CONFIGURATION OF TERMINAL BY USING NAS MESSAGE IN WIRELESS COMMUNICATION SYSTEM

(71) Applicant: Samsung Electronics Co., Ltd., Suwon-si, Gyeonggi-do (KR)

(72) Inventor: Kyungjoo SUH, Suwon-si (KR)

(21) Appl. No.: 18/837,037

(22) PCT Filed: Feb. 9, 2023
(86) PCT No.: PCT/KR2023/001935

§ 371 Date: Aug. 8, 2024

(30) Foreign Application Priority Data
Feb. 9, 2022 (KR) 10-2022-0017201

(51) Int. Cl. H04W 24/02; H04W 8/22; H04W 12/06; H04W 12/106; H04W 60/04

(52) U.S. Cl. CPC H04W 24/02; H04W 8/22; H04W 12/06; H04W 12/106; H04W 60/04

(57) ABSTRACT

The present disclosure relates to a method and an apparatus for managing a configuration of a UE in a wireless communication system, and the method, performed by the UE, in a wireless communication system including a first non-public network and a second non-public network according to an embodiment of the present disclosure comprises the steps of: receiving, by the UE accessed to the first non-public network, a NAS message including configuration information for use of a service provided in the second non-public network from a first AMF of the first non-public network; and on the basis of the configuration information received by the UE from the first non-public network, performing a procedure of registration to a second AMF of the second non-public network.

### CROSS-REFERENCE TO RELATED APPLICATIONS

This application is a U.S. National Phase Entry of PCT International Application No. PCT/KR2023/001935, which was filed on Feb. 9, 2023, and claims priority to Korean Patent Application No. 10-2022-0017201, which was filed on Feb. 9, 2022 in the Korean Intellectual Property Office, the entire disclosure of which is incorporated herein by reference.

### TECHNICAL FIELD

The disclosure relates to a device and a method for managing configuration of a UE in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G.

In the initial stage of 5G mobile communication technologies, in order to support services and to satisfy performance requirements in connection with enhanced Mobile BroadBand, (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as V2X for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is impossible, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR, VR, and the like (XR=AR+VR+MR), 5G performance improvement and complexity reduction by utilizing Artificial Intelligence (AI) and Machine Learning (MLE), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DETAILED DESCRIPTION OF THE INVENTION

### Technical Problem

The disclosure provides an apparatus and a method for managing the configuration of a UE using NAS messages in a wireless communication system.

The disclosure also provides a method and an apparatus for managing the configuration of a UE connected to a non-public network in a wireless communication system.

The disclosure also provides a method and an apparatus for providing configuration information related to the use of a network slice to a UE using NAS messages in a wireless communication system.

### Technical Solution

According to an embodiment of the disclosure, a method performed by a UE in a wireless communication system including a first non-public network and a second non-public network includes receiving, by the UE connected to the first non-public network, a non-access stratum (NAS) message including configuration information for use of a service provided in the second non-public network from a first access and mobility management function (AMF) of the first non-public network, and performing, by the UE, a registration procedure to a second AMF of the second non-public network, based on the configuration information received from the first non-public network.

In addition, according to an embodiment of the disclosure, a UE in a wireless communication system including a first non-public network and a second non-public network includes a transceiver, and a processor configured to receive, through the transceiver, a NAS message including configuration information for use of a service provided in the second non-public network from a first AMF of the first non-public network to which the UE is connected, and enable the UE to perform a registration procedure to a second AMF of the second non-public network, based on the configuration information received from the first non-public network.

In addition, according to an embodiment of the disclosure, a method performed by an AMF of a first non-public network to which a UE is connected in a wireless communication system including a first non-public network and a second non-public network, the method includes, in case that parameter update related to use of a service of the UE occurs in the second non-public network, receiving a first message notifying of the parameter update from a user data management (UDM) managing subscription information of the UE in a home network of the UE, and transmitting a second message including verification-related information of the parameter update to the UE through a radio access network (RAN) of the first non-public network, based on the reception of the first message, wherein the parameter update is related to configuration information for use of the service in the second non-public network.

In addition, according to an embodiment of the disclosure, an AMF of a first non-public network to which a UE is connected, in a wireless communication system including a first non-public network and a second non-public network, the AMF includes a transceiver, and a processor configured to receive, when parameter update related to use of a service of the UE occurs in the second non-public network, a first message notifying of the parameter update from a UDM configured to manage subscription information of the UE in a home network of the UE, and transmit a second message including verification-related information of the parameter update to the UE through a RAN of the first non-public network, based on the reception of the first message, through the transceiver, wherein the parameter update is related to configuration information for use of the service in the second non-public network.

### BRIEF DESCRIPTION OF DRAWINGS

FIG. 1 is a diagram illustrating an example of the configuration of a 5G system for managing configuration of a UE according to an embodiment of the disclosure.

FIG. 2 is a flowchart illustrating a procedure for providing updated configuration information to a UE using a NAS message in a 5G system according to an embodiment of the disclosure.

FIG. 3 is a diagram illustrating a method for a UE to receive updated configuration information through a NAS message in a 5G system according to an embodiment of the disclosure.

FIG. 4 is a diagram illustrating a method for an AMF to transmit updated configuration information through a NAS message in a 5G system according to an embodiment of the disclosure.

FIG. 5 is a diagram illustrating the configuration of a UE in a 5G system according to an embodiment of the disclosure.

FIG. 6 is a diagram illustrating the configuration of a network entity in a 5G system according to an embodiment of the disclosure.

### MODE FOR CARRYING OUT THE INVENTION

Hereinafter, embodiments of the disclosure will be described with reference to the accompanying drawings. In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the 3rd generation partnership project long term evolution (3GPP LTE) or 3GPP NR standards or terms and names modified based thereon will be used for the sake of descriptive convenience. However, the disclosure is not limited by the above terms and names, and may be applied in the same way to systems that conform other standards. In the disclosure, a base station is an entity that allocates resources to user equipment (UE), and may be at least one of a gNode B, a gNB, an eNode B, an eNB, a Node B, a base station (BS), a wireless access unit, a base station controller, and a node on a network. The base station may be a network entity including at least one of an integrated access and backhaul-donor (IAB-donor) which is a gNB providing network access to a UE(s) via a network of backhaul and access links, and an IAB-node which is an RAN node supporting an NR access link(s) to a UE(s) and supporting NR backhaul links to the IAB-donor or any other IAB-node. In the disclosure, the UE may be not only cellular phones, mobile stations (MSs), smartphones, computers, NB-IoT devices, and sensors, but also various wireless communication devices.

That is, the following detailed description of embodiments of the disclosure will be mainly directed to the 5G system defined by 3GPP NR standards, but based on determinations by those skilled in the art, the main idea of the disclosure may also be applied to other communication systems having similar technical backgrounds through some modifications without significantly departing from the scope of the disclosure.

The 5G system may support network slices, and traffic for different network slices may be processed by different protocol data unit (PDU) sessions. The PDU session may indicate an association between a data network that provides a PDU connection service and a UE. The network slice may be understood as a technology that logically configures a network as a set of network functions (NFs) to support various services with different characteristics, such as broadband communication services, massive IoT, or mission critical services such as V2X, and separates different network slices from each other. Therefore, even if communication disruptions occur in a network slice, since the communication of other network slices is not affected, it is possible to provide stable communication services. In the disclosure, “slice” may be used interchangeably with the term “network slice”. In such a network environment, a UE may connect to multiple network slices when using various services. In addition, the above network function (NF) is a software instance running in hardware, and may be implemented as a virtualized function instantiated in a network element or an appropriate platform.

A mobile communication service provider may configure the network slice and allocate network resources suitable for a specific service to each network slice or a set of network slices. The network resources may indicate NFs or logical resources provided by the NFs, or wireless resource allocation of a base station.

For example, the mobile communication service provider may configure network slice A to provide mobile broadband services, configure network slice B to provide vehicle communication services, and configure network slice C to provide broadcast services. That is, as described above, the 5G network may efficiently provide the relevant services to the UE through network slices specialized for the characteristics of each service. In the 5G system, the network slice may be represented as single-network slice selection assistance information (S-NSSAI).

The S-NSSAI includes a slice/service type (SST) and a slice differentiator (SD), which are essential information indicating a network slice. The SD is optional information for further segmenting multiple network slices indicated by the same SST, and may be used, for example, to indicate a user group of a network slice. Here, the S-NSSAI may be divided into standard S-NSSAI and non-standard S-NSSAI. The standard S-NSSAI may include standard SSTs such as eMBB, uRLLC, mIoT, and V2X, but may not include the SD. In this case, the standard S-NSSAI may represent multiple network slices. Meanwhile, the non-standard S-NSSAI may be defined as a case where non-standard SSTs (defined by the telecommunications operator), excluding eMBB, uRLLC, mIoT, and V2X, are included but the SD is not included, and a case where both the standard SSTs and the SD are included. In this case, the non-standard S-NSSAI may represent a single network slice.

In the 5G system, an access and mobility management function (AMF), which is the management entity that manages the mobility of a UE, and a session management function (SMF), which is the entity that manages sessions, are separated. Accordingly, unlike the 4G LTE communication system where a mobility management entity (MME) performs mobility management and session management together, the entity for mobility management and the entity for session management are separated in the 5G system, so that the communication method and communication management method between the UE and the network entity may vary.

In the 5G system, for non-3GPP access in a non-public network (NPN), mobility management may be performed through the AMF via a non-3GPP inter-working function (N3IWF), and session management may be performed through the SMF. In addition, security-related information, which is an important element for mobility management, may also be processed through the AMF.

Meanwhile, in the 5G system, the non-public network (NPN) is a vertical-only 5G system that is an independent 5G system, which is separated from the general 5G mobile communication system and provides performance specialized for a specific operator and dedicated services only to UEs registered as the operators. The 3GPP Rel-16 standard classifies the NPNs into two types, for example, 1) a stand-alone NPN (SNPN) that is not dependent on a telecommunications operator, and 2) a public-network integrated NPN capable of being linked with existing mobile communication systems., and the two types are different in that whether or not the infrastructure of 5G mobile communication system of a general telecommunications operator is utilized for NPN services. First, the SNPN, which is an NPN that does not utilize the 5G mobile communication system infrastructure of a general telecommunications operator, has a separate PLMN ID and network ID, and requires an independent registration procedure for the UE. Second, the NPN dependent on the telecommunications operator supports an independent 5G network through slicing in the form of leasing the 5G mobile communication system infrastructure of a general telecommunications operator or supports an independent 5G network distinguished from the general 5G mobile communication system through a closed access group (CAG) identifier.

In addition, an inter-working function (IWF), which connects the NPNs with the 5G operator networks, may perform mobility management through the AMF and perform session management through the SMF.

As explained above, the MME serves to perform both mobility management and session management in the 4G LTE system. The 5G system may support a non-standalone architecture that performs communication using the network entities of the 4G LTE system together, as well as a standalone architecture that uses only the network entities of the 5G system.

The disclosure is proposed to solve the communication inconsistency problem that occurs due to the configuration mismatch between the non-public network (NPN) and the UE in the case where a function supported in one non-public network is not supported in another non-public network in a network environment including the above-mentioned non-public network.

Therefore, the disclosure may solve the above-mentioned problem by performing communication that provides configuration information related to the use of at least one function (e.g., a service or a network slice) in the non-public network using the non-access stratum (NAS) protocol in the network environment including the non-public network. The configuration information may include security information related to the use of the at least one function.

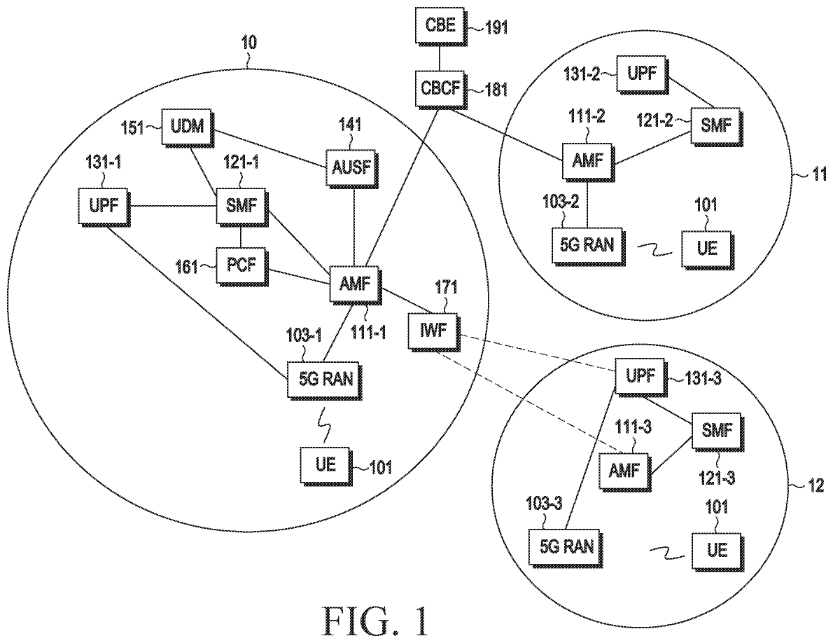

FIG. 1 is a diagram illustrating an example of the configuration of a 5G system for managing configuration of a UE according to an embodiment of the disclosure. The example shown in FIG. 1 assumes a situation in which a UE 101 may connect to a home public land mobile network (HPLMN) 10, non-public network A (11), or non-public network B (12) as the UE 101 moves. In the example in FIG. 1, although the UE 101 is illustrated in each network 10, 11, or 12 for convenience of explanation, it does not indicate that the UE 101 is connected to all networks 10, 11, and 12, and the UE 101 may be connected to any one of the networks 10, 11, and 12 as the UE 101 moves. In addition, the example in FIG. 1 may be applied to network selection of the UE 101, as well as to physical movement of the UE 101.

In the disclosure, the network technology may refer to standard specifications (e.g., TS 23.501, TS 23.502, TS 23.503, or the like) defined by the International Telecommunication Union (ITU) or 3GPP, and the components included in the network structure in FIG. 1 may indicate physical entities, software performing respective functions, or hardware combined with the software.

The 5G system in FIG. 1 may include a 5G RAN (hereinafter, RAN) and a 5GC (5G core network), and the RAN may be a base station (e.g., gNB, integrated access and backhaul (IAB), or the like) supporting wireless access technology in the 5G system.

Referring to FIG. 1, the 5GC may be configured as a user plane function (UPF) 131-1, 131-2, or 131-3, a session management function (SMF) 121-1, 121-2, or 121-3, an access and mobility management function (AMF) 111-1, 111-2, or 111-3, a radio access network (RAN) 103-1, 103-2, or 103-3, user data management (UDM) 151, a network function (NF) such as a policy control function (PCF) 161, a cell broadcast center function (CBCF) 181, and a cell broadcast entity (CBE) 191.

The AMF 111-1, 111-2, or 111-3 is an entity for managing the access and mobility of the UE 101. For example, the AMF 111-1, 111-2, or 111-3 may perform network functions such as registration, connection, reachability, mobility management, access identification, authentication, and mobility event generation of the UE 101.

The SMF 121-1, 121-2, or 121-3 may perform a management function for a protocol data unit (PDU) session of the UE 101. For example, the SMF 121-1, 121-2, or 121-3 may perform network functions such as a session management function for establishing, modifying, and releasing session and maintaining tunnel between the UPF 131-1, 131-2, or 131-3 and the RAN 103-1, 103-2, or 103-3, an Internet protocol (IP) address allocation and management function of the UE 101, selection and control of user plane, traffic processing control in the UPF 131-1, 131-2, or 131-3, and charging data collection control.

The UPF 131-1, 131-2, or 131-3 may serve to process data of the UE 101 or process data so as to transmit the data transmitted by the UE 101 to an external network or so as to transmit the data received from an external network to the UE 101. For example, the UPF 131-1, 131-2, or 131-3 may perform network functions such as playing an anchor role between radio access technologies (RATs), providing connection between PDU sessions and AFs, packet routing and forwarding, packet inspection, applying user plane policies, producing traffic usage reports, and buffering.

The UDM 151 may perform functions such as producing authentication information for 3GPP security, processing user identifiers (user IDs), managing a list of network functions (NFs) supporting the UE 101, and managing subscription information. The PCF 161 is an NF that manages operator policy information for providing services in the 5G system. The CBCF 181 and the CBE 191 are entities related to broadcasting disaster messages or the like.

In addition, the 5G system may include entities such as an authentication server function (AUSF) 141, authentication, authorization, and accounting (AAA) (not shown), and the like for authentication of the network entities. The UE 101 may access the 5GC through the base station 103-1, 103-2, or 103-3. Meanwhile, the UE 101 may perform communication through non-3GPP access, and in this case, an N3 interworking function (N3IWF) may exist, and the IWF 171 may operate as the N3IWF. In the case where the UE 101 performs non-3GPP access through the non-public network A (11) or non-public network B (12), session management for the UE 101 may be controlled by the SMF 121-2 or 121-3, and mobility management for the UE 101 may be controlled by the AMF 111-2 or 111-3.

In the 5G system, the entities performing mobility management and session management are separated into the AMF 111 and the SMF 121, respectively. Meanwhile, a stand-alone (SA) deployment structure in which communication is performed using only 5G entities and a non-stand-alone (NSA) deployment structure using both 4G entities and 5G entities may be applied to the 5G system.

Referring to the example in FIG. 1, when the UE 101 communicates with the network, the control thereof is performed by the base station 103-1, 103-2 or 103-3, enabling deployment in the form in which the 5G entities of the core network are used. In this case, mobility management between the UE 101 and the AMF 111-1, 111-2 or 111-3 and session management between the UE 101 and the SMF 121-1, 121-2 or 121-3 may be performed in the non-access stratum (NAS) of layer 3. Meanwhile, the process in the access stratum (AS) of layer 2 may be transferred between the UE 101 and the base station 103-1, 103-2 or 103-3.

Referring to FIG. 1, as described above, the UE 101 may be connected to any one of the networks 10, 11, and 12 according to movement between the networks 10, 11, and 12. For example, the UE 101 may move from the HPLMN 10 to the non-public network A (11) or move from the non-public network A (11) to the non-public network B (12). At least one network slice supported by the non-public network A (11) and the non-public network B (12) may differ therebetween. For example, it may be assumed that the non-public network A (11) does not support the network slice B, but the non-public network B (12) supports the network slice B. In this case, if the UE 101 moves from the non-public network A (11) to the non-public network B (12), the UE 101 may access the non-public network B (12) and receive services from the network slice B. At this time, if configuration information for access to the non-public network B (12) is pre-provided to UE 101, the access failure problem due to mismatch of configuration information may be resolved, and the UE 101 may easily access the non-public network B (12) supporting the network slice B using the configuration information pre-provided from non-public network A (11).

In the embodiment in FIG. 1, when the UE 101 moves from the non-public network A (11) to the non-public network B (12) in the case where a service (or network slice), which is not supported in the non-public network A (11), is supported in the non-public network B (12), if configuration information including capability information for the service (or network slice) is pre-configured (pre-provided) to the UE 101, the UE 101 may easily (or without interruption) use the service. Therefore, in the disclosure, in order for the UE 101 to be able to easily (or without interruption) use the service in the non-public network to which the UE 101 has moved, the UE 101 may be provided with configuration information including UE-related parameters (e.g., capability information) supported (provided) by the network in relation to the service (or network slice) in advance, thereby improving the convenience of service use in the non-public network to which the UE 101 has moved. The configuration information including the UE-related parameters (e.g., capability information) may be provided from the non-public network A (11) or HPLMN 10. To this end, in the disclosure, a message, transmitted to the UE 101 from the network to provide the configuration information, may include at least one of the following a), b), and c) information as capability information for the UE 101 to use (access) the services in the non-public network. The message may use, for example, an NAS message.
a) Information about a service (network slice) or data network that the UE accessing the non-public network is able to receive (use)
b) Service (network slice) authentication-related information
c) PDU session authentication information related to a service (network slice)

The PDU session authentication information may include information for authenticating the corresponding data network when establishing or modifying the PDU session.

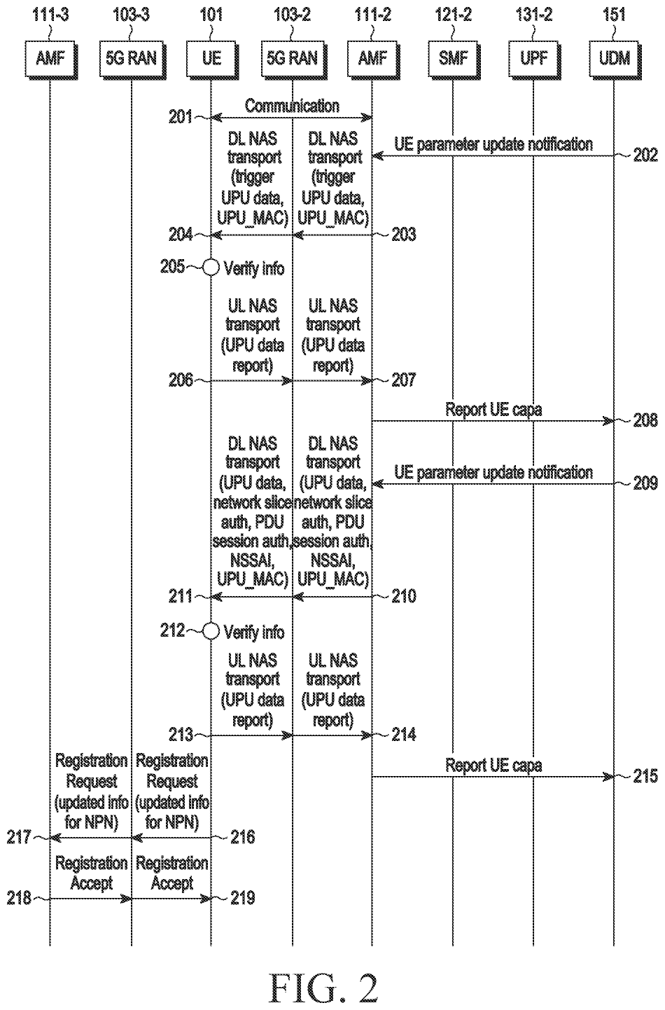

FIG. 2 is a flowchart illustrating a procedure for providing updated configuration information to a UE using a NAS message in a 5G system according to an embodiment of the disclosure. The procedure in FIG. 2 will be described with reference to the configuration in FIG. 1.

In the example in FIG. 2, it is assumed that subscription information of the UE 101 is managed in the UDM 151 of the HPLMN 10 and that the UE 101 moves to the non-public network B (12) while performing communication in the non-public network A (11). In addition, it is assumed that functions such as the network slice B and specific PDU session support, which are not supported in the public network A (11), are supported in the non-public network B (12). In addition, in the example in FIG. 2, configuration information for the network slice B of the UE 101 may be updated before the UE 101 moves in order for the UE 101 to perform communication with respect to the network slice B supported in the non-public network B (12), so that when the UE 101 moves to the non-public network B (12), the UE 101 may perform a registration procedure to the non-public network B (12), based on the updated configuration information. The updated configuration information may be provided to the UE 101 using a NAS message, and the updated configuration information may include at least one of the information a), b), and c) described above as capability information for the UE 101 to use (access) services in the non-public network.

Specifically, in step 201, it is assumed that the UE 101 is performing communication in the non-public network A (11).

In step 202, a first UE parameter update notification for updating the parameters of the UE 101 may be transmitted from the UDM 151 of the HPLMN 10 of the UE 101 to the AMF 111-2 in the non-public network A (11). Meanwhile, the UDM 151 may be triggered to transmit the first UE parameter update notification when updating the parameters related to the use of the network slice B of the UE 101. The first UE parameter update notification may use Nudm_SDM_Notification message specified in 3GPP NR standards and TS 23.502 V16.x.x. In the example in FIG. 2, although the first UE parameter update notification is illustrated as being transmitted from the UDM 151 of the HPLMN 10 to the AMF 111-2 of the non-public network A (11) in step 202 for convenience, the first UE parameter update notification may also be transmitted through signaling between network entities such as the AMF 111-1 and IWF 171 of the HPLMN 10 and the AMF 111-2 of the public network A (11).

In steps 203 and 204, a first downlink (DL) NAS transport message is transmitted from the AMF 111-2 to the UE 101 via the RAN 103-2. The first DL NAS transport message includes UPU_MAC (message authentication code) information for verification of UE parameter update (UPU) and is transmitted. The UPU_MAC information may be used for verification of UPU data received through the first DL NAS transport message. In steps 203 and 204, the first DL NAS transport message is transmitted to the UE 101 to trigger a UPU process, and it is not identified whether the network slice B has been already configured in the capability of the UE 101, so the first DL NAS transport message may not include the updated configuration information.

In step 205, the UE 101 that received the UPU data may verify whether or not the received UPU data is falsified (modified, deleted, inserted, etc.) using the UPU_MAC information (e.g., integrity check). Here, the received UPU data may include data used for verification to trigger the UPU process.

In steps 206 and 207, if the received UPU data is not falsified as a result of the verification in step 205, the UE 101 transmits a second UL NAS transport message including a UPU data report to the AMF 111-2 via the RAN 103-2. The UPU data report may include current capability information of the UE 101 in relation to whether not to identification is performed to use the network slice B. Based on the UPU data report, the network may determine whether or not to transmit the updated configuration information to the UE 101.

In step 208, the AMF 111-2 may report the current capability information of the UE 101 to the UDM 151. Although it has been illustrated that the current capability information is transmitted from the AMF 111-2 of the public network A (11) to the UDM 151 of the HPLMN 10 in step 208 for convenience, the current capability information may also be transmitted through signaling between network entities such as the AMF 111-1 and IWF 171 of the HPLMN 10 and the AMF 111-2 of the public network A (11).

Meanwhile, if the network is ware of the current capability of the UE 101, steps 202 to 208 may be omitted.

In step 209, if the current capability information of the UE 101 does not include configuration information related to the use of the network slice B, the UDM 151 may transmit, to the AMF 111-2, a second UE parameter update notification message including configuration information for updating the parameters related to the use of the network slice B of the UE 101. The second UE parameter update notification may use the Nudm_SDM_Notification message specified in TS 23.502 V16.x.x. If the current capability information of the UE 101 includes configuration information related to the use of the network slice B, the subsequent steps thereof may be omitted from FIG. 2. The embodiment in FIG. 2 assumes that the current capability information of the UE 101 does not include configuration information related to the use of the network slice B. The updated configuration information may include authentication information for the use of the network slice B. The updated configuration information may include a network slice to be accessed when the UE 101 moves to the non-public network B (12), information related to network slice authentication required for establishing a PDU session, and information related to PDU session authentication. The updated configuration information may include at least one of the information a), b), and c) described above as capability information for service use (access) in the non-public network. In addition, the updated configuration information may further include information indicating whether or not to perform a registration procedure to the non-public network B (12) in relation to the use of the network slice B when the UE 101 connects (moves) to the non-public network B (12). In steps 210 and 211, the AMF 111-2 of the non-public network A (11) may transmit the UE parameter update data (i.e., the updated configuration information) received from the UDM 151 in step 209 to the UE 101 via the RAN 103-2 using a third DL NAS transport message. The updated configuration information may include authentication information for the use of the network slice B in the non-public network B (12) as described above.

Alternatively, as an example, the updated configuration information may include information about NSSAA, i.e., credentials for network slice authentication, PDU session authentication credentials, default configured NSSAI, or the like. Here, the NSSAA credential may be credential information used to authenticate the network slice, and the PDU session authentication credential may be credential information for PDU session authentication.

In step 212, the UE 101 that received the UPU data in the third DL NAS transport message may verify whether or not the UPU data is falsified (modified, deleted, inserted, etc.) using UPU_MAC information (e.g., integrity check). Here, the received UPU data may include data used for verification.

In step 212, if the UE 101 succeeds in the verification, the UE 101 updates the parameters related to the use of the network slice B of the UE 101, which are possessed by the UE 101, based on the updated configuration information received in the third DL NAS transport message. Alternatively, the UE 101 may further store the received updated configuration information in addition to the capabilities that is possessed by the UE 101, and further use the UE 101-related parameters. In addition, although the UPU data for verification is described separately in the third DL NAS transport message in the embodiment of the disclosure, it may also be possible to include the updated configuration information in the UPU data. In steps 213 and 214, if the received UPU data is not falsified as a result of the verification in step 212, the UE 101 may transmit a fourth UL NAS transport message including a UPU data report to the AMF 111-2 via the RAN 103-2. The UPU data report may include current capability information of the UE 101 configured to be able to use the network slice B. Based on the UPU data report, the network may identify that the updated configuration information related to the use of the network slice B is configured to the UE 101.

In step 215, the AMF 111-2 may report current capability information of the UE 101 to the UDM 151. Although it has been illustrated that the current capability information is transmitted from the AMF 111-2 of the public network A (11) to the UDM 151 of the HPLMN 10 in step 215 for convenience, the current capability information may also be transmitted through signaling between network entities such as the AMF 111-1 and IWF 171 of the HPLMN 10 and the AMF 111-2 of the public network A (11).

In subsequent steps 216 and 217, if the UE 101 moves from the non-public network A (11) to another non-public network, for example, the non-public network B (12), the UE 101 may perform a registration procedure by transmitting a registration request to the AMF 113-3 of the non-public network B (12), based on the updated configuration information including the authentication information pre-received from the non-public network A (11).

The registration request message transmitted in steps 216 and 217 may include a UE parameter update support information element indicating whether or not the UE supports UE parameter update. In an embodiment, this information may be a general information element. In another embodiment, this information may be a transparent container information element. Meanwhile, in an embodiment, the UE parameter update support may use parameters such as MAC message authentication code or the like in order to verify whether or not the UE and the network have sent correct information, and this may include UPU_MAC_I_{UE}, COUNTER_{UE}, and the like. This UPU_MAC_I_{UE} and COUNTER_{UE} information is used as UPU acknowledgement indicating that UE parameters update is successful. Meanwhile, in an embodiment, for the UE parameter update support, information to distinguish between the default configured NSSAI update data described above, credentials for NSSAA, PDU session authentication or authorization, and the like may be transmitted from the UE to the network in the form of a type, an indication, or a list of specific bits.

In steps 218 and 219, the UE 101 receives a registration accept for the registration request from the AMF 113-3.

Afterwards, the UE 101 may establish a PDN connection, related to the network slice B supported by the non-public network B (12), with the non-public network B (12) using the updated configuration information.

Meanwhile, in the embodiment in FIG. 2 described above, although the example in which the UE 101 that received the updated configuration information from the non-public network A (11) performs the registration procedure to the non-public network B (12) is illustrated, as another example, if the UE 101 moves back to the non-public network A (11), the UE 101 may perform a (re)registration procedure to the non-public network A (11).

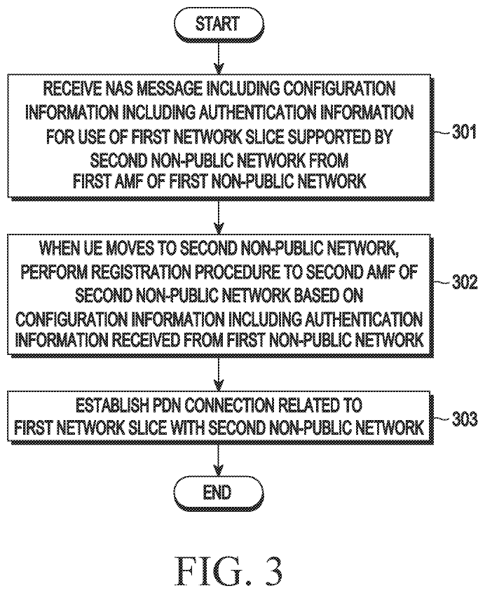

FIG. 3 is a diagram illustrating a method for a UE to receive updated configuration information through a NAS message in a 5G system according to an embodiment of the disclosure.

FIG. 3 illustrates a method of a UE 101 receiving updated configuration information through a NAS message in the procedure shown in FIG. 2. Referring to FIG. 3, in step 301, the UE 101 receives an NAS message including updated configuration information including authentication information for use of a first network slice (i.e., the network slice B) supported by a second non-public network 12 (i.e., the non-public network B) from a first AMF 111-2 of a first non-public network 11 (i.e., the non-public network A). The first AMF 111-2 may receive the updated configuration information from the UDM 151 that manages subscription information of the UE 101.

In step 302, when the UE 101 moves to the second non-public network 12, the UE 101 may perform a registration procedure to a second AMF 111-3 of the second non-public network 12, based on the configuration information including authentication information pre-received from the first non-public network 11. Thereafter, in step 303, the UE 101 may establish a PDN connection related to the first network slice with the second non-public network 12.

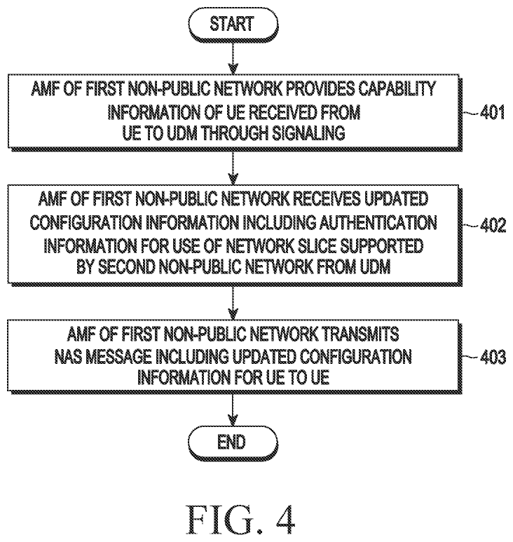

FIG. 4 is a diagram illustrating a method for an AMF to transmit updated configuration information through a NAS message in a 5G system according to an embodiment of the disclosure.

FIG. 4 shows a method for an AMF 111-2 to transmit updated configuration information through a NAS message in the procedure shown in FIG. 2. Referring to FIG. 4, in step 401, the AMF 111-2 of the first non-public network 11 (i.e., the non-public network A) may provide capability information of the UE 101 received from the UE 101 to the UDM 151 through signaling. In step 402, the AMF 111-2 of the first non-public network 11 may receive updated configuration information including authentication information for the use of a network slice (i.e., the network slice B) supported by the second non-public network 12 (i.e., the non-public network B) from the UDM 151. Thereafter, in step 403, the AMF 111-2 of the first non-public network 11 may transmit a NAS message including updated configuration information for the UE 101 to the UE 101.

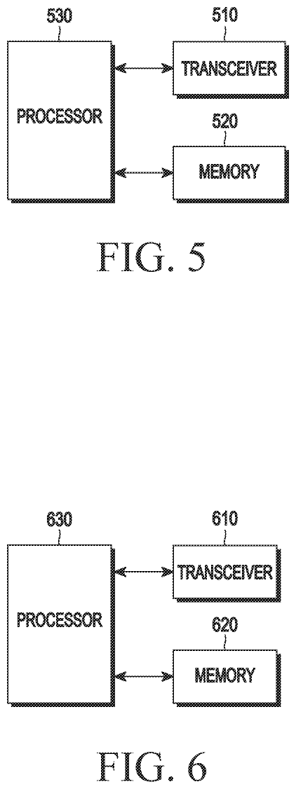

FIG. 5 is a diagram illustrating the configuration of a UE in a 5G system according to an embodiment of the disclosure.

As illustrated in FIG. 5, the UE of the disclosure may include a transceiver 510, memory 520, and a processor 530. In the embodiments in FIGS. 1 to 4, the processor 530, the transceiver 510, and the memory 520 of the UE may operate according to the communication method of the UE 101 described above. However, the components of the UE are not limited to the examples described above. For example, the UE may include more or fewer components than the components described above. In addition, the processor 530, the transceiver 510, and the memory 520 may be implemented in the form of a single chip.

The transceiver 510 is a general term encompassing the receiver of the UE and the transmitter of the UE, and the UE may transmit and receive signals to and from a base station or a network entity through the transceiver 510. The signals that the UE transmits and receives to and from the base station may include at least one of control information and data. To this end, the transceiver 510 may be configured to include an RF transmitter that up-converts and amplifies the frequency of a transmitted signal, an RF receiver that low-noise amplifies a received signal and down-converts the frequency, and the like. However, this is only an embodiment of the transceiver 510, and the components of the transceiver 510 are not limited to the RF transmitter and RF receiver.

In addition, the transceiver 510 may include a wired/wireless transceiver and include various configurations for transmitting and receiving signals.

In addition, the transceiver 510 may receive a signal through a wireless channel, output the same to the processor 530, and transmit a signal output from the processor 530 through the wireless channel.

In addition, the transceiver 510 may receive a communication signal and output the same to the processor 530, and transmit a signal output from the processor 530 to a network entity through a wired/wireless network.

The memory 520 may store programs and data necessary for the operation of the UE according to at least one of the embodiments in FIGS. 1 to 4. In addition, the memory 520 may store control information or data included in a signal acquired in the UE. The memory 520 may be configured as a storage medium such as a ROM, a RAM, a hard disk, a CD-ROM, and a DVD or a combination thereof.

The processor 530 may control a series of processes such that the UE may operate according to at least one of the embodiments in FIGS. 1 to 4. The processor 530 may include at least one processor. For example, the processor 530 may include a communication processor (CP) that performs control for communication and an application processor (AP) that controls upper layers such as applications programs.

FIG. 6 is a diagram illustrating the configuration of a network entity in a 5G system according to an embodiment of the disclosure.

As illustrated in FIG. 6, the network entity of the disclosure may include a transceiver 610, memory 620, and a processor 630. In the embodiments in FIGS. 1 to 4, the processor 630, the transceiver 610, and the memory 620 of the network entity may operate according to the communication method of the network entity described above. However, the components of the network entity are not limited to the examples described above. For example, the network entity may include more or fewer components than the components described above. In addition, the processor 630, the transceiver 610, and the memory 620 may be implemented in the form of a single chip. The network entity in FIG. 6 may include network functions (NFs) such as the AMF, the UDM base station (RAN), and the like described in the embodiments in FIGS. 1 to 4.

The transceiver 610 is a general term encompassing the receiver of the network entity and the transmitter of the network entity, and may transmit and receive signals to and from the UE or another network entity. In this case, the signals transmitted and received may include at least one of control information and data. To this end, the transceiver 610 may be configured to include an RF transmitter that up-converts and amplifies the frequency of a transmitted signal, an RF receiver that low-noise amplifies a received signal and down-converts the frequency, and the like. However, this is only an embodiment of the transceiver 610, and the components of the transceiver 610 are not limited to the RF transmitter and RF receiver. The transceiver 610 may include a wired/wireless transceiver and include various configurations for transmitting and receiving signals.

In addition, the transceiver 610 may receive a signal through a communication channel (e.g., wireless channel), output the same to the processor 630, and transmit a signal output from the processor 630 through the communication channel.

In addition, the transceiver 610 may receive a communication signal and output the same to the processor 630, and transmit a signal output from the processor 630 to the UE or network entity through a wired/wireless network.

The memory 620 may store programs and data necessary for the operation of the network entity according to at least one of the embodiments in FIGS. 1 to 4. In addition, the memory 620 may store control information or data included in a signal acquired in the network entity. The memory 620 may be configured as a storage medium such as a ROM, a RAM, a hard disk, a CD-ROM, and a DVD or a combination thereof.

The processor 630 may control a series of processes such that the network entity may operate according to at least one of the embodiments in FIGS. 1 to 4. The processor 630 may include at least one processor. Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

1. A method performed by a user equipment (UE) in a wireless communication system comprising a first non-public network and a second non-public network, the method comprising:
receiving, by the UE connected to the first non-public network, a non-access stratum (NAS) message comprising configuration information for use of a service provided in the second non-public network from a first access and mobility management function (AMF) of the first non-public network; and
performing, by the UE, a registration procedure to a second AMF of the second non-public network, based on the configuration information received from the first non-public network.

2. The method of claim 1, wherein the configuration information comprises at least one of:
information about a network slice corresponding to the service that the UE connected to the second non-public network is able to use,
information about a data network related to the network slice,
authentication-related information for use of the network slice, and
protocol data unit (PDU) session authentication information related to the network slice.

3. The method of claim 2, further comprising:
receiving, by the UE, a first message comprising verification-related information of parameter update in relation to use of the service from the first AMF; and
in case that the parameter update is verified based on the verification-related information, transmitting a second message comprising capability information of the UE related to use of the network slice corresponding to the service to the first AMF.

4. The method of claim 3,
wherein the configuration information is received based on the capability information of the UE, and
wherein the configuration information comprises at least one of first information for the parameter update related to use of the network slice and second information indicating whether or not to perform the registration procedure in the UE.

5. The method of claim 3, further comprising:
updating, by the UE, parameters related to use of the network slice in the second non-public network, based on the configuration information.

6. A user equipment (UE) in a wireless communication system comprising a first non-public network and a second non-public network, the UE comprising:
a transceiver; and
a processor configured to:
receive, through the transceiver, a non-access stratum (NAS) message comprising configuration information for use of a service provided in the second non-public network from a first access and mobility management function (AMF) of the first non-public network to which the UE is connected, and
enable the UE to perform a registration procedure to a second AMF of the second non-public network, based on the configuration information received from the first non-public network.

7. (canceled)

8. A method performed by a first access and mobility management function (AMF) of a first non-public network to which a user equipment (UE) is connected in a wireless communication system comprising the first non-public network and a second non-public network, the method comprising:
in case that parameter update related to use of a service of the UE occurs in the second non-public network, receiving a first message notifying of the parameter update from a user data management (UDM) managing subscription information of the UE in a home network of the UE; and
transmitting a second message comprising verification-related information of the parameter update to the UE through a radio access network (RAN) of the first non-public network, based on the reception of the first message,
wherein the parameter update is related to configuration information for use of the service in the second non-public network.

9. The method of claim 8, wherein the configuration information comprises at least one of:
information about a network slice corresponding to the service that the UE connected to the second non-public network is able to use,
information about a data network related to the network slice,
authentication-related information for use of the network slice, and
protocol data unit (PDU) session authentication information related to the network slice.

10. The method of claim 8, further comprising:
in response to transmission of the verification-related information of the parameter update, receiving capability information of the UE from the UE; and
transmitting the capability information of the UE to the UDM.

11. The method of claim 10, further comprising:
receiving the configuration information comprising authentication information for use of a network slice corresponding to the service in the second non-public network from the UDM; and
transmitting a non-access stratum (NAS) message comprising the configuration information to the UE.

12. The method of claim 11, wherein the verification-related information comprises a message authentication code (MAC) for verification of the parameter update.

13. A first access and mobility management function (AMF) of a first non-public network to which a user equipment (UE) is connected in a wireless communication system comprising the first non-public network and a second non-public network, the AMF comprising:
a transceiver; and
a processor configured to:
receive, in case that parameter update related to use of a service of the UE occurs in the second non-public network, a first message notifying of the parameter update from a user data management (UDM) managing subscription information of the UE in a home network of the UE, and
transmit a second message comprising verification-related information of the parameter update to the UE through a radio access network (RAN) of the first non-public network, based on the reception of the first message, through the transceiver,
wherein the parameter update is related to configuration information for use of the service in the second non-public network.

14. (canceled)

15. The UE of claim 6, wherein the configuration information comprises at least one of:
information about a network slice corresponding to the service that the UE connected to the second non-public network is able to use,
information about a data network related to the network slice,
authentication-related information for use of the network slice, and
protocol data unit (PDU) session authentication information related to the network slice.

16. The UE of claim 15, wherein the processor is further configured to:
receive, through the transceiver, a first message comprising verification-related information of parameter update in relation to use of the service from the first AMF, and
in case that the parameter update is verified based on the verification-related information, transmit, through the transceiver, a second message comprising capability information of the UE related to use of the network slice corresponding to the service to the first AMF.

17. The UE of claim 16, wherein the configuration information is received based on the capability information of the UE, and wherein the configuration information comprises at least one of first information for the parameter update related to use of the network slice and second information indicating whether or not to perform the registration procedure in the UE.

18. The UE of claim 16, wherein the processor is further configured to:
update parameters related to use of the network slice in the second non-public network, based on the configuration information.

19. The AMF of claim 13, wherein the configuration information comprises at least one of:
information about a network slice corresponding to the service that the UE connected to the second non-public network is able to use,
information about a data network related to the network slice,
authentication-related information for use of the network slice, and
protocol data unit (PDU) session authentication information related to the network slice.

20. The AMF of claim 13, wherein the processor is further configured to:
in response to transmission of the verification-related information of the parameter update, receiving capability information of the UE from the UE, and
transmit, through the transceiver, the capability information of the UE to the UDM.

21. The AMF of claim 20, wherein the processor is further configured to:
receive, through the transceiver, the configuration information comprising authentication information for use of a network slice corresponding to the service in the second non-public network from the UDM, and
transmit, through the transceiver, a non-access stratum (NAS) message comprising the configuration information to the UE.

22. The AMF of claim 21, wherein the verification-related information comprises a message authentication code (MAC) for verification of the parameter update.
